(19) United States
(12) Patent Application Publication
(10) Pub. No.: US 2004/0092353 A1
(43) Pub. Date: May 13, 2004

(54) Single regime power split tranmission

(76) Inventor: Frank Moeller, Milford (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/297,480

(22) PCT Filed: Jun. 7, 2001
(86) PCT No.: PCT/GB01/02495

(30) Foreign Application Priority Data
Jun. 7, 2000 (GB) 0013727.3

(51) Int. Cl. F16H 3/72; B60K 6/04

(52) U.S. Cl. 475/5

(57) ABSTRACT

A transmission comprises a first epicyclic train (23) having a first carrier member (23), which carries at least one first planet member (24) which is in driving engagement with a first annulus member (26) and with a first sun wheel (19) member and a second epicyclic train (34) comprising a second carrier member (33), which carries at least one second planet member (31) which is in driving engagement with a second annulus member (30) and with a second sun wheel (18) member wherein the first carrier member (23) is connected to the second annulus member (30) and the first (19) and second sun wheel (18) members being connected together, the first annulus (26) is connected to ground through a first electric motor (13) and the second sun wheel (18) is connected to ground through a second electric motor (15), one of said members of the first train (23) provides an input to said transmission and one of said members of the second train (34) provides an output of said transmission and there being control means to permit the speed of said motors (13, 15) to be varied to vary the output speed of the transmission.

This invention relates to a transmission in or for an automotive vehicle with at least two wheels and of up to approximately 5 tonnes gross weight. Such a transmission is referred to hereinafter as being of the kind specified.

An object of the invention is to provide a new and improved transmission of the kind specified.

According to the invention we provide a transmission of the kind specified comprising a first epicyclic train having a first carrier member, which carries at least one first planet member which is in driving engagement with a first annulus member and with a first sun wheel member and a second epicyclic train comprising a second carrier member, which carries at least one second planet member which is in driving engagement with a second annulus member and with a second sun wheel member wherein the first carrier member is connected to the second annulus member and the first and second sun wheel members being connected together, the first annulus is connected to ground through a first electric motor and the second sun wheel is connected to ground through a second electric motor, one of said members of the first train provides an input to said transmission and one of said members of the second train provides an output of said transmission and there being control means to permit the speed of said motors to be varied to vary the output speed of the transmission.

The first carrier of the first train may provide an input of the said transmission.

The second carrier of the second train may provide an output of said transmission.

The output of the transmission may be connected to the wheels of a vehicle.

The output of the transmission may provide an input to at least one other transmission.

The output of the other transmission or of at least one of the other transmissions may be connected to the wheels of a vehicle.

The output of the transmission or of the other transmission or of at least one of the other transmissions may be connected to the wheels of a vehicle via a clutch means and/or a differential means.

The first motor may comprise a rotor connected to the first annulus member and a stator connected to ground.

The first annulus member may be mounted to rotate fixedly with the rotor of the first motor.

The second motor may comprise a rotor connected to the second sun gear member.

The first sun member and the second sun member may be fixed to rotate with a shaft and the rotor of the second motor may also be adapted to rotate with said shaft.

The first sun member, second sun member and the rotor of the second motor may be longitudinally disposed on said shaft in said order.

Bearing means may be provided between the first carrier member and the first annulus member.

Alternatively, the first planet members and the first annulus member may be mutually supported by virtue of said interengagement therebetween.

All the interengaging members may comprise gear wheels.

Further alternatively, the first planetary members may comprise taper rollers in frictional engagement with said first annulus member and said first sun wheel member.

Biasing means may be provided to bias said planetary members into said frictional engagement and reaction means may be provided for said first annulus member and said first sun wheel member.

Each electric motor may be a switched reluctance motor.

The transmission may be a power split transmission in which means are provided to supply electrical power to one of said motors from the other of said motors.

As a result the transmission does not require any external electrical power supply.

The transmission may be provided with an electrical energy storage means in which electrical power generated by either of said motors is stored.

For example, when the transmission is operated at a relatively slow speed and/or the vehicle is braking an amount of electrical power is generated which is not required by either motor and this is stored in the energy storage means.

Power may be supplied from the energy storage means to at least one, of said motors to limit variation in the amount of power supplied to one or other of said motors.

The input of the transmission may be connected to an engine such as an internal combustion engine or an electric motor or indeed any other type of prime mover. Alternatively the input may be connected to an output of any design form of transmission from a prime mover.

The output of the transmission may be connected to the wheels of a vehicle but may be connected into another transmission of any kind including, for example, another power split transmission. Any vehicle within which the transmission is provided may be provided with a plurality of transmissions according to the present invention.

Three embodiments of the invention will now be described by way of example with reference to the accompanying drawings wherein:

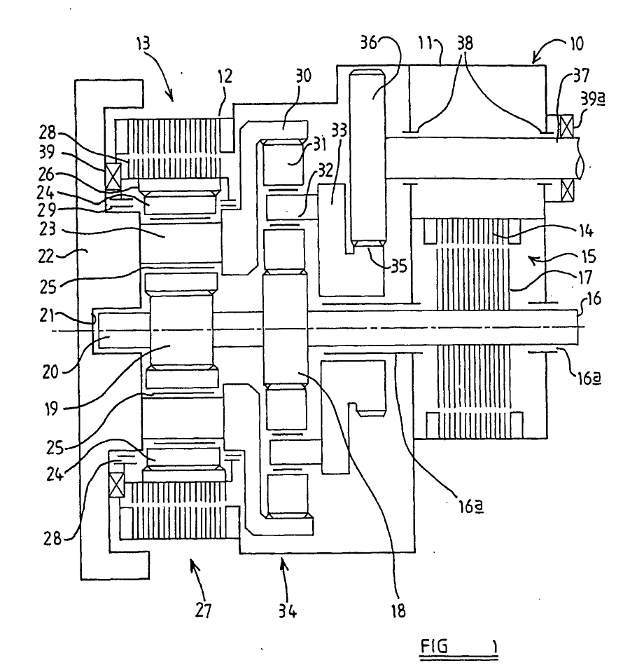

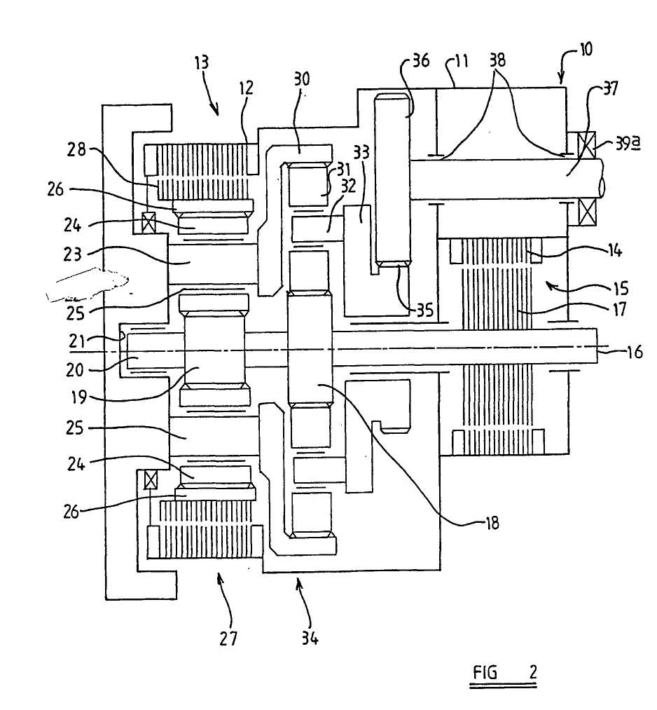

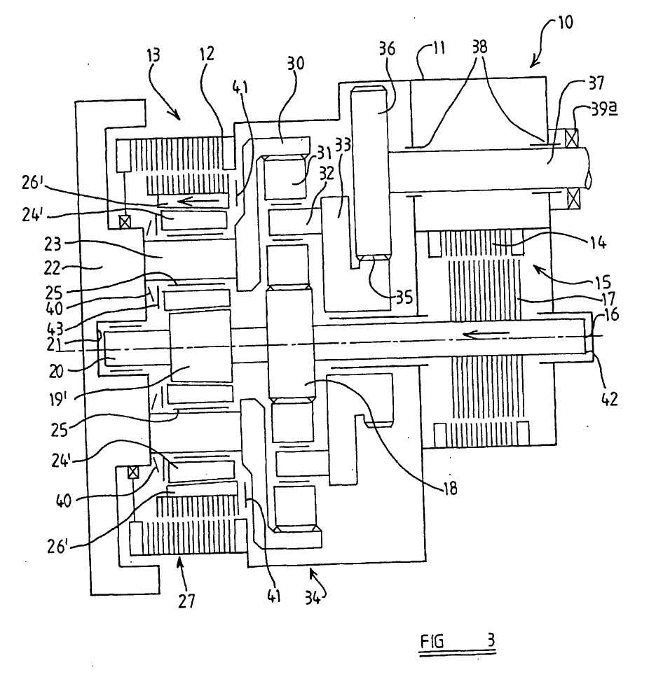

FIG. 1 is a diagrammatic representation of a first transmission embodying the invention,

FIG. 2 is a diagrammatic representation of a second transmission embodying the invention,

FIG. 3 is a diagrammatic representation of a third embodiment of the invention,

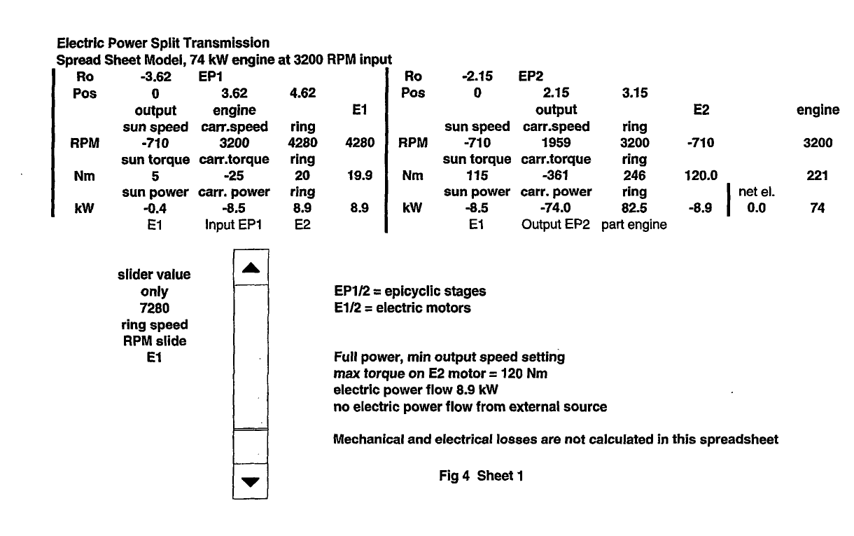

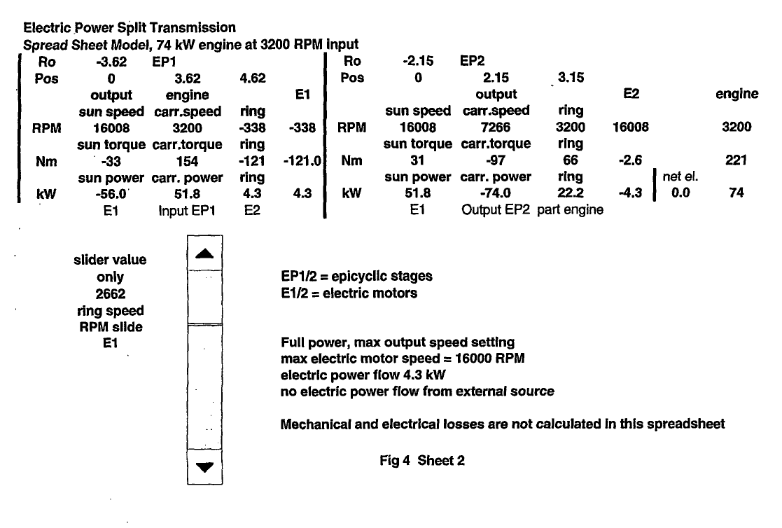

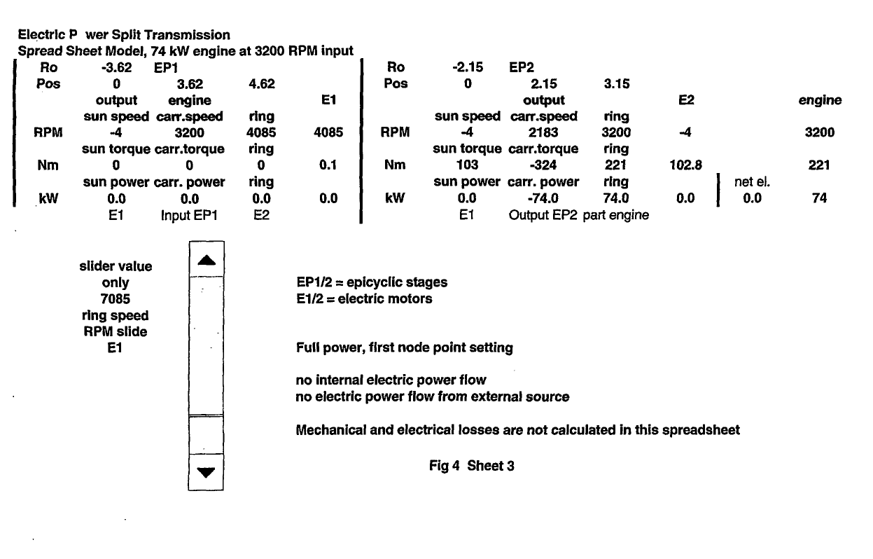

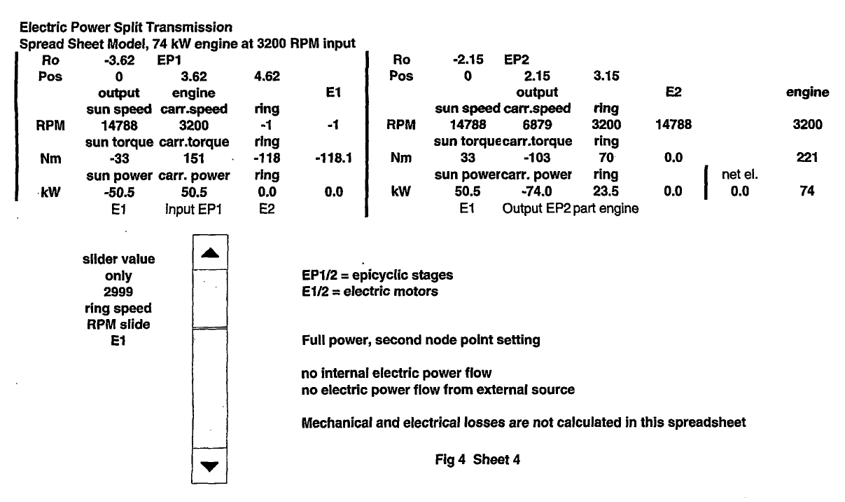

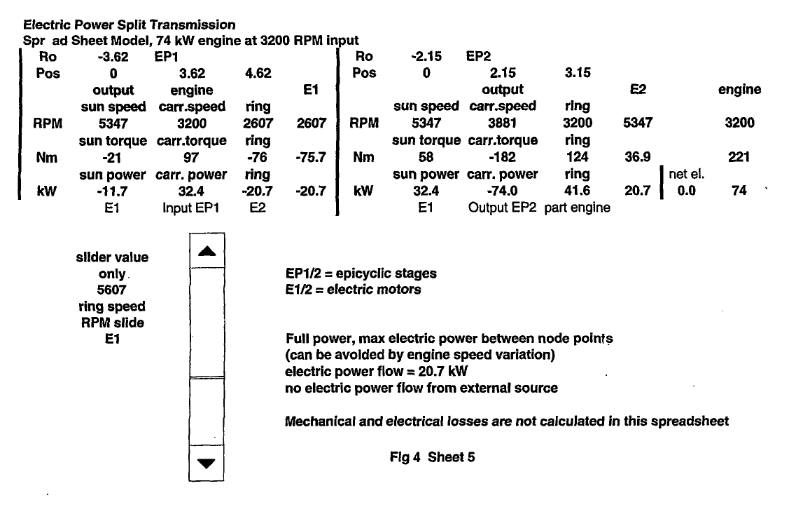

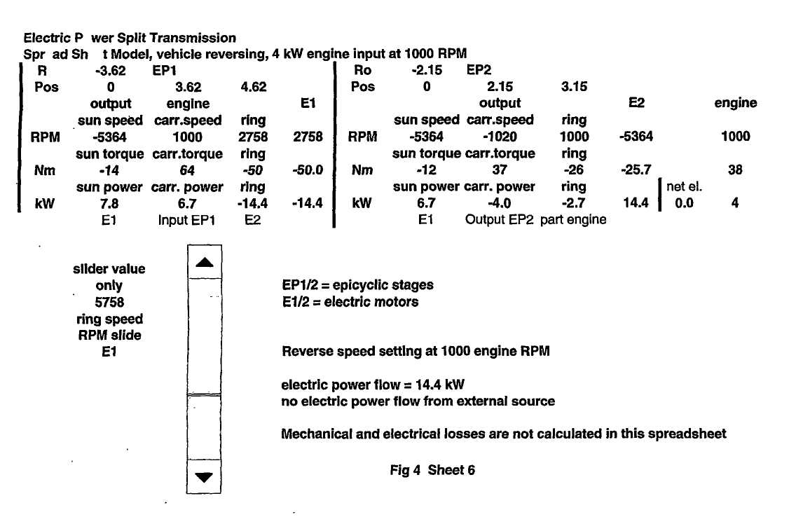

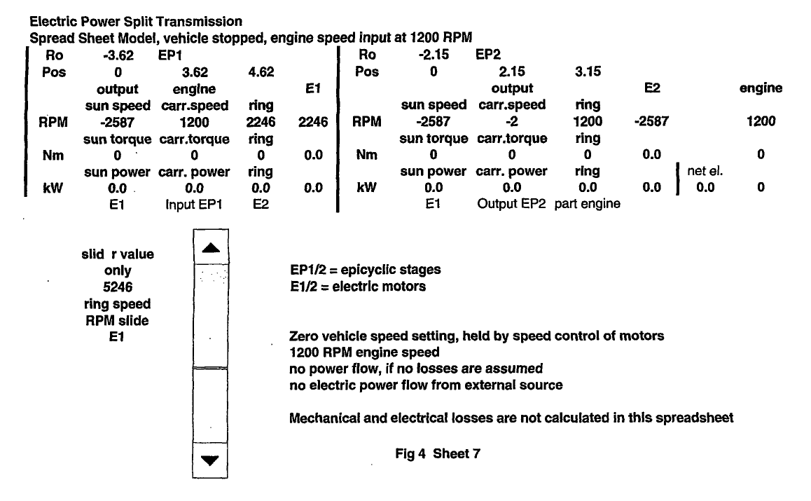

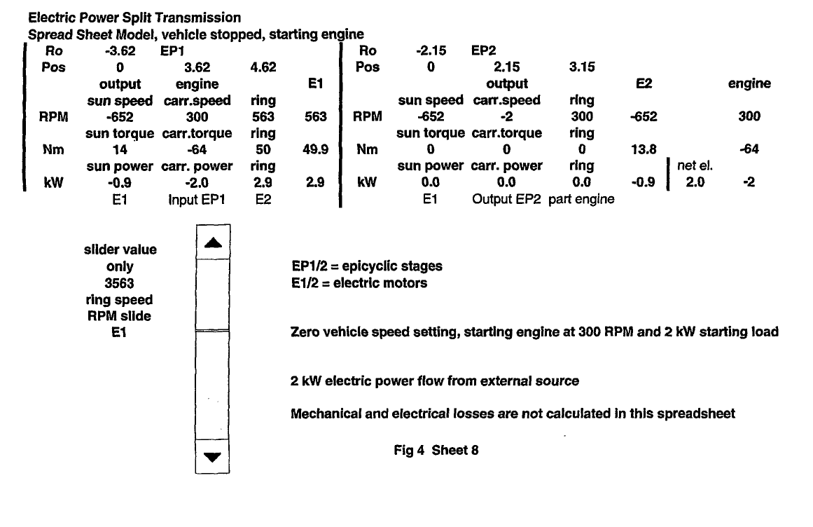

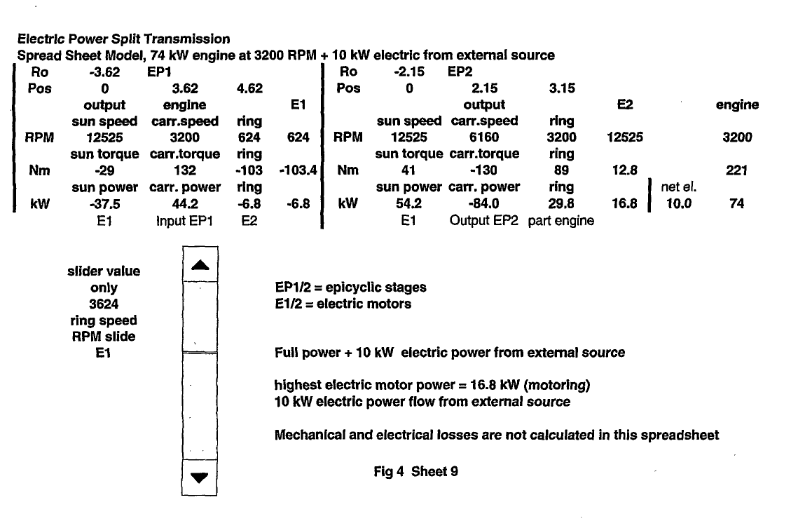

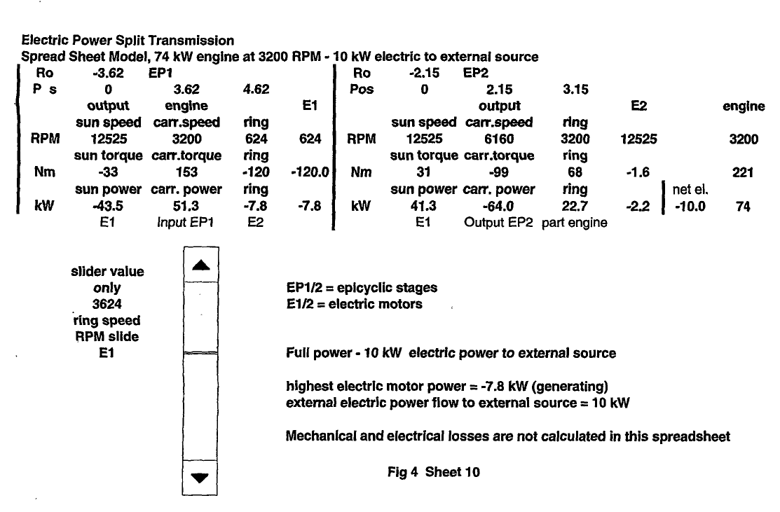

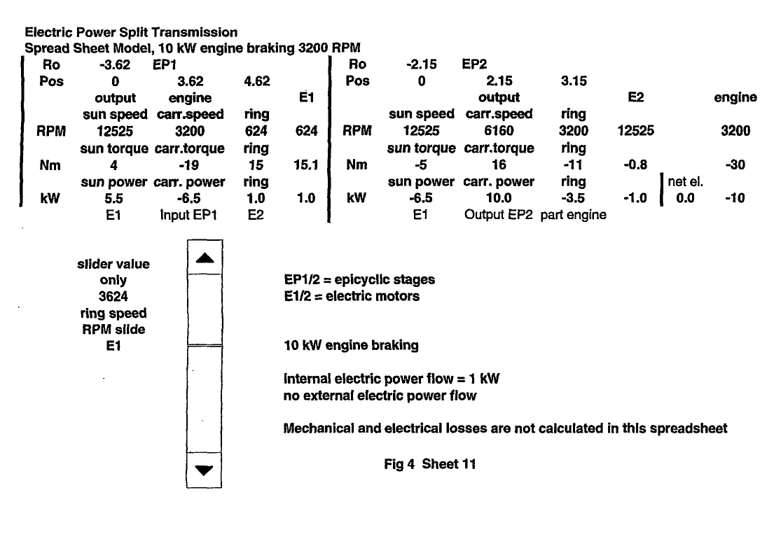

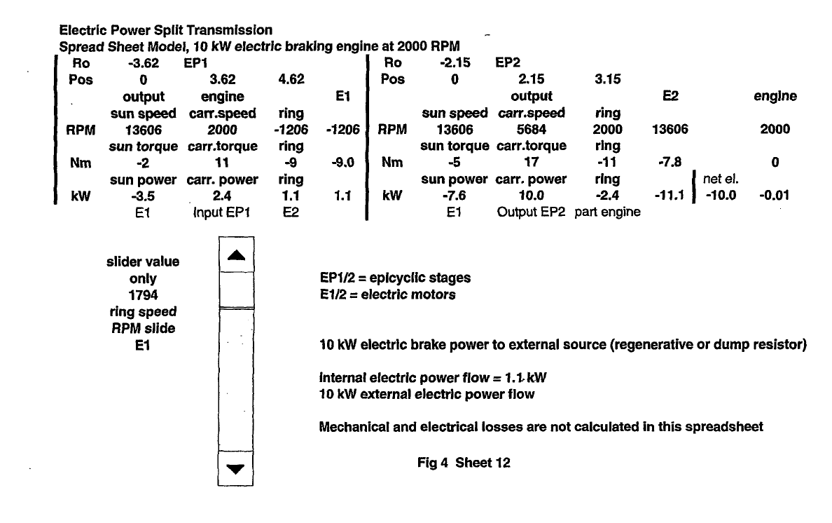

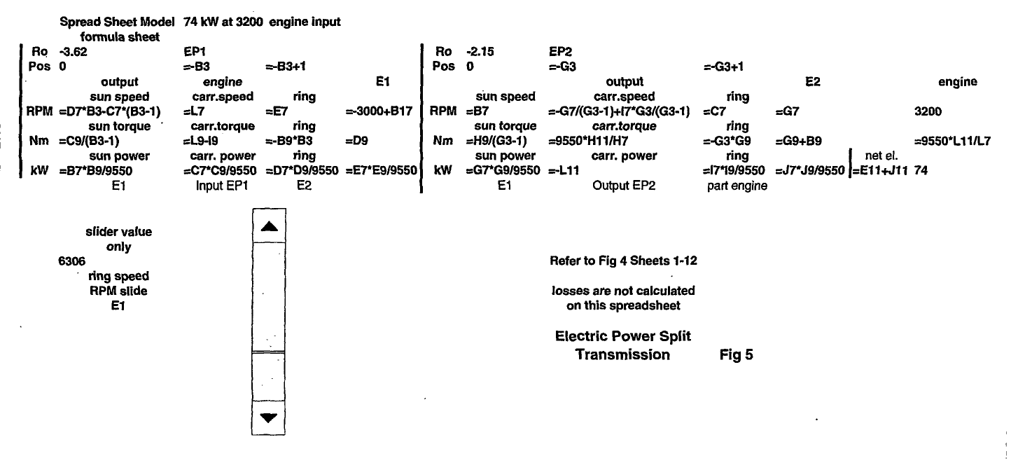

FIG. 4 comprises twelve tables setting out details of the transmission described herein when connected to a prime mover comprising a 74 kilowatt internal combustion engine operating at 3200 rpm with the transmission set at the twelve different settings referred to in each sheet,

FIG. 5 is a spreadsheet setting out how the figures shown in Sheets 1-12 of FIG. 4 have been calculated, and

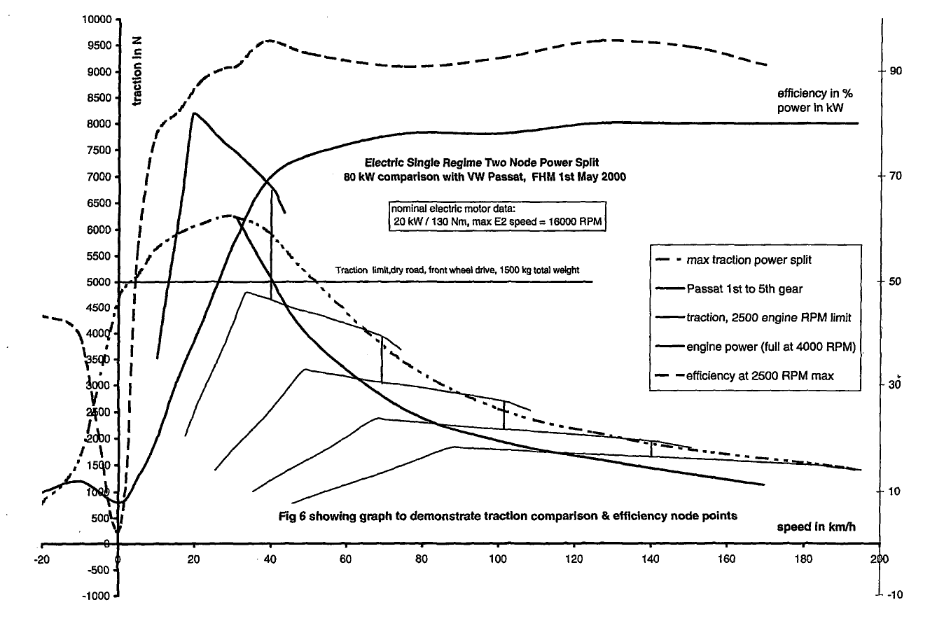

FIG. 6 is a graphical illustration in which traction and efficiency are plotted against speed.

Referring now to FIG. 1, a transmission is indicated generally at 10 and comprises a housing 11 which provides a ground.

Fixed to the housing 11 is a stator 12 of a first electric motor 13. In the present example, electric motor 13 is of the “switched reluctance” type. The housing 11 also has fixed thereto a stator 14 of a second electric motor 15 also of the “switched reluctance” type.

The housing 11 also carries, via a suitable bearing means 16a, a shaft 16 which is rotatable relative to the housing 11 and fixedly carries a rotor 17 of the motor 15, a second sun wheel member 18 and a first sun wheel member 19, each of which comprises a gear. In addition a bearing, not shown, is provided between an end part 20 of the shaft 16 and a recess 21 provided in a flywheel 22 of a prime mover. The flywheel 22 also provides a first carrier member having a plurality of shafts 23, three in the present example, on each of which a first planet member 24 is rotatably mounted by bearing means 25.

The planet members 24 comprise gears which are in mesh with an annulus member 26, which also comprise a gear, and thus the first annulus member 26, first planetary member 24 together with the first carrier member 23 and the first sun wheel member 19 provide a first epicyclic, gear, train 27.

The annulus member 26 fixedly carries a rotor 28 of the first electric motor 12. Suitable bearing means 29 are provided between the first annulus member 26 and the first carrier member 23.

The first carrier 23 is also connected to a second annulus member 30 which comprises a gear which is in mesh with the second planet members 31 carried by shafts 32 of a second carrier member 33.

The number of first planet members and second planet members although comprising three, in each case, in the present example may be less or more than this figure and either the same or a different number of planet wheels may be provided in each epicyclic train.

The planet members 31 comprises gears are also in mesh with the second sun, gear, member 18 and so the second annulus member 30, said planet member 31 and second sun wheel member 18 together provide a second epicyclic, gear, train 34.

The second carrier member 33 is provided with a set of gear teeth 35 which mesh with a gear 36 carried on a shaft 37 which is carried in bearings 38 carried by the housing 11.

An oil seal 39 is provided between the flywheel 22 and the housing 11. Similarly an oil seal 39a is provided between the housing 11 and the output shaft 37. The shaft 37 is connected, where desired, by a clutch to, for example, wheels or other item to be driven by the transmission and, if desired, in addition, or alternatively, at least one differential may be connected to the shaft 37.

In use, the flywheel 22 is driven by a prime mover which, for example, may be an internal combustion engine or may be of any other desired type including for example an electric motor. The flywheel 22 is rotated either at a constant speed by the prime mover or the speed of the prime mover is varied so as to vary the speed of rotation of the flywheel. In either case the power provided to the first electric motor 13 from the second electric motor 15 or vice versa is varied as desired to achieve a desired torque split between the two differentials therefore providing a desired output speed of the shaft 37. The variation in the speed of the motors is preferably achieved by a suitable electronic controller programmed according to the desired output of the transmission.

No external electrical power is required to be supplied since electrical power generated by one of the electric motors by rotation of the rotor of the electric motor relative to the stator may be fed to the other electric motor so as to drive its rotor with the electrical power thus generated.

Referring now to FIG. 2, in which the same reference numerals have been used as were used in FIG. 1 for corresponding parts. This embodiment is similar to that shown in FIG. 1 but differs from that shown in FIG. 1 by virtue of the absence of a separate bearing means between the first annular member and the first carrier member 23. In this case the gears are manufactured accurately so that the gears interengage and act as a bearing means. In addition the first rotor 29 is symmetrically disposed relative to the stator 12 so as to avoid any axial loads. In addition, the planet members are equally spaced so that there are no offset loads to upset the balance.

In the embodiment shown in FIG. 3, again the same reference numerals have been used to refer to corresponding parts as were used in FIG. 1 but in this case instead of the first annulus member 26 being provided with teeth which engage with the teeth of the first planetary wheel members 24, which are themselves engaged with the first sun gear 19, the first annulus member, first planetary members and first sun wheel are formed as tapered rollers, which are axially forced into engagement to provide a frictional drive;For this reason these components are indicated in FIG. 3 by the same reference numbers as used in FIGS. 1 and 2 with the addition of a prime sign.

The required axial load is achieved by providing the Belleville washers indicated at 40 in FIG. 3 which serve to urge the first planetary wheel members 24′ to the right in FIG. 3 and so cause frictional engagement between the first planetary wheel members 24′ and the first annulus member 26′ and the first sun wheel member 19′ respectively. To accommodate the thrust thus provided by the Belleville washers 40, thrust bearing means 41, 42 are provided. In addition, because of built in non-symmetrical disposition of the stator and rotor 26, 28 on rotation additional magnetic loads which are torque dependent will be created which are supported by the thrust bearing means 43.

It should be noted that for starting the engine it is not necessary to disengage any clutches with which the engine may be provided since the electric motors can keep the vehicle stationary during the starting procedure. If a clutch is provided and if it is disengaged in an emergency then the electric motors can synchronise the relevant clutch halves for easy engagement.

In any of the embodiments described hereinbefore if desired energy storage means, for example a suitable battery, may be connected to at least one and preferably to both of the motors. As a result when the transmission is operated at a relatively slow speed and/or the vehicle is braking an amount of electrical power is generated and this is fed to and stored in the energy storage means.

Power may be supplied from the energy storage means to at least one of the motors to limit variation in the amount of power supplied to the other of said motors.

If desired electrical power may be supplied to other external means such as regenerative or dump resistor to assist in braking of the engine for example as shown in Sheet 12 of FIG. 4.

It is important to maintain the power requirements of the electrical motors to a minimum to reduce cost and to increase transmission efficiency particularly as electrical control of motors can be expensive for high powers and the efficiency of motors and generators combined is not greater than for example 80% whereas mechanical efficiency can be as high as 97% for example.

The present invention provides a power shaft transmission which circulates relatively little electrical power, especially if the engine speed is always readjusted by the vehicle controller to run the transmission close to one of the electrical power node points. These node points occur, when one of the motors is at a standstill and therefore cannot generate nor absorb any power. This is the condition shown in Sheets 3 and 4 of FIG. 4.

It will be clear to a person of skill in the art that for each different vehicle and engine combination the ratios of the transmission have to be adjusted to make the node points most effective.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A transmission of the kind specified comprising a first epicyclic train having a first carrier member, which carries at least one first planet member which is in driving engagement with a first annulus member and with a first sun wheel member and a second epicyclic train comprising a second carrier member, which carries at least one second planet member which is in driving engagement with a second annulus member and with a second sun wheel member wherein the first carrier member is connected to the second annulus member and the first and second sun wheel members are connected together, the first annulus is connected to ground through a first electric motor and the second sun wheel is connected to ground through a second electric motor, one of said members of the first train provides an input to said transmission and one of said members of the second train provides an output of said transmission and there being control means to permit the speed of said motors to be varied to vary the output speed of the transmission.

2. A transmission according to claim 1 wherein the first carrier of the first train provides an input of the said transmission.

3. A transmission according to claim 1 or claim 2 wherein the second carrier of the second train provides an output of said transmission.

4. A transmission according to any one of the preceding claims wherein the output of the transmission is connected to the wheels of a vehicle.

5. A transmission according to any one of claims 1 to 3 wherein the output of the transmission provides an input to at least one other transmission.

6. A transmission according to claim 5 wherein the output of the other transmission or of at least one of the other transmissions is connected to wheels of a vehicle.

7. A transmission according to any one of claims 4 to 6 wherein the output of the transmission or said other transmission or at least one of the other transmisisons is connected to the wheels of a vehicle via a clutch means and/or a differential means.

8. A transmission according to any one of the preceding claims wherein the first motor comprises a rotor connected to the first annulus member and a stator connected to ground.

9. A transmission according to claim 8 wherein the first annulus member is mounted to rotate fixedly with the rotor of the first motor.

10. A transmission according to any one of the preceding claims wherein the second motor comprises a rotor connected to the second sun gear member.

11. A transmission according to claim 10 wherein the first sun member and the second sun member are fixed to rotate with a shaft and the rotor of the second motor is also be adapted to rotate with said shaft.

12. A transmission according to claim 11 wherein the first sun member, second sun member and the rotor of the second motor are longitudinally disposed on said shaft in said order.

13. A transmission according to any one of the preceding claims wherein bearing means are provided between the first carrier member and the first annulus member.

14. A transmission according to any one of claims 1 to 12 wherein the first planet members and the first annulus member are mutually supported by virtue of said interengagement therebetween.

15. A transmission according to claim 14 wherein all the interengaging members comprise gear wheels.

16. A transmission according to claim 14 wherein the first planetary members comprise taper rollers in frictional engagement with said first annulus member and said first sun wheel member.

17. A transmission according to claim 16 wherein biasing means are provided to bias said planetary members into said frictional engagement and reaction means may be provided for said first annulus member and said first sun wheel member.

18. A transmission according to any one of the preceding claims wherein each electric motor is a switched reluctance motor.

19. A transmission according to any one of the preceding claims wherein the transmission is a power split transmission in which means are provided to supply electrical power to one of said motors from the other of said motors.

20. A transmission according to any one of the preceding claims wherein the transmission is provided with an electrical energy storage means in which electrical power generated by either of said motors is stored.

21. A transmission according to claim 20 wherein the power is supplied from the energy store to at least one of said motors.

22. A transmission substantially as hereinbefore described with reference to FIG. 1 or FIG. 2 or FIG. 3 and FIGS. 4 to 6 of the accompanying drawings.

23. A transmission according to any one of the preceding claims wherein the transmission is connected to another transmission.

24. A transmission according to claim 22 wherein said other transmission is of the same kind as the transmission claimed in claims 1 to 22 is of a different kind.

25. Any novel feature or novel combination of features described herein and/or in the accompanying drawings.
